(19) United States
(12) Patent Application Publication
(10) Pub. No.: US 2012/0098796 A1
(43) Pub. Date: Apr. 26, 2012

(54) OPTICAL TOUCH MODULE AND DATA LOADING METHOD THEREOF

(75) Inventor: Chi-Te Lin, Taichung City (TW)

(73) Assignee: SONIX Technology Co., Ltd., Hsinchu (TW)

(21) Appl. No.: 13/273,241

(22) Filed: Oct. 14, 2011

(30) Foreign Application Priority Data
Oct. 20, 2010 (TW) 099135778

(51) Int. Cl. G06F 3/042; G06F 12/02

(52) U.S. Cl. 345/175; 711/103; 711/E12.008

(57) ABSTRACT

An optical touch module and a data loading method thereof are provided. The optical touch module includes a first system-on-chip (SoC), a second SoC and a storage element. The first and the second SoCs are electrically connected to each other and disposed around a touch region of a substrate. The first and the second SoCs each include an image sensor for sensing an image of the touch region. The storage element is electrically connected to the first SoC. The first SoC reads first data and second data stored in the storage element and transmits the second data to the second SoC. The first and the second SoCs respectively process the image of the touch region according to the first data and the second data.

### CROSS-REFERENCE TO RELATED APPLICATION

This application claims the priority benefit of Taiwan application serial no. 099135778, filed on Oct. 20, 2010. The entirety of the above-mentioned patent application is hereby incorporated by reference herein and made a part of this specification.

### BACKGROUND OF THE INVENTION

1. Field of the Invention

The present invention relates to a touch module, in particular, to an optical touch module and a data loading method thereof.

2. Description of Related Art

A plurality of programmable chips, such as a system-on-chip (SOC) and a micro controller, is often disposed in an electronic system. Different data (for example, an execution program for an algorithm or a parameter required by the algorithm) is stored in each of the programmable chips. Each of the programmable chips operates according to different data to complete respective preset functions.

However, when the data in the programmable chips needs to be adjusted/changed, in a conventional technology, the programmable chips need to be reprogrammed or refilled one by one. Obviously, it is very time-consuming and labor-force-consuming to adjust/change the data in the programmable chips as described in the conventional technology.

### SUMMARY OF THE INVENTION

Accordingly, the present invention is directed to architecture and a data loading method of an optical touch module, which improve the flexibility and efficiency in the process of adjusting/changing data.

An embodiment of the present invention provides an optical touch module, which includes a first SoC, a second SoC and a storage element. The first and the second SoCs are electrically connected to each other and disposed around a touch region of a substrate. The first and the second SoCs each include an image sensor for sensing an image of the touch region. The storage element is electrically connected to the first SoC. The first SoC reads first data and second data stored in the storage element and transmits the second data to the second SoC. The first and the second SoCs respectively process the images of the touch region according to the first data and the second data.

An embodiment of the present invention provides a data loading method of an optical touch module, where the optical touch module includes a first SoC and a second SoC electrically connected to each other. The first and the second SoCs are disposed around a touch region of a substrate. The first and the second SoCs each include an image sensor for sensing an image of the touch region. The data loading method includes: enabling the first SoC to read a second data stored in a storage element; transmitting the second data from the first SoC to the second SoC; and enabling the first SoC to read a first data stored in the storage element. The first and the second SoCs respectively process the image of the touch region according to the first data and the second data.

In an embodiment of the present invention, the optical touch module further includes a third SoC electrically connected to the first SoC. The third SoC is disposed around the touch region. The third SoC includes an image sensor for sensing an image of the touch region. The first SoC further reads a third data stored in the storage element and transmits the third data to the third SoC, and the third SoC processes the image of the touch region according to the third data.

In an embodiment of the present invention, the optical touch module further includes a third SoC electrically connected to the second SoC. The third SoC is disposed around the touch region. The third SoC includes an image sensor for sensing an image of the touch region. The first SoC further reads a third data stored by the storage element and transmits the third data to the third SoC through the second SoC, and the third SoC processes the image of the touch region according to the third data.

Based on above description, the embodiments of the present invention provide the architecture and the data loading method of the optical touch module. The SoCs include program RAMs, in which the data (for example, the program or parameter) to be executed can be loaded from outside. When the data of the SoCs is adjusted/changed, only the content of the storage element connected to the first SoC needs to be changed, and the SoCs do not need to be reprogrammed one by one. Therefore, the embodiments of the present invention can improve the flexibility and efficiency in the process of adjusting/changing the data.

In order to make the features and advantages of the present invention clearer and more comprehensible, the present invention is described in detail below with reference to embodiments and the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view of an architecture of an optical touch module according to an embodiment of the present invention;

FIG. 2 is a schematic view of a connection architecture of a plurality of SoCs shown in FIG. 1 according to an embodiment of the present invention;

FIG. 3 is a flow chart of a data loading method of the optical touch module shown in FIG. 2 according to an embodiment of the present invention;

FIG. 4 is a schematic view of a connection architecture of a plurality of SoCs shown in FIG. 1 according to another embodiment of the present invention; and

FIG. 5 is a flow chart of a data loading method of the optical touch module shown in FIG. 4 according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

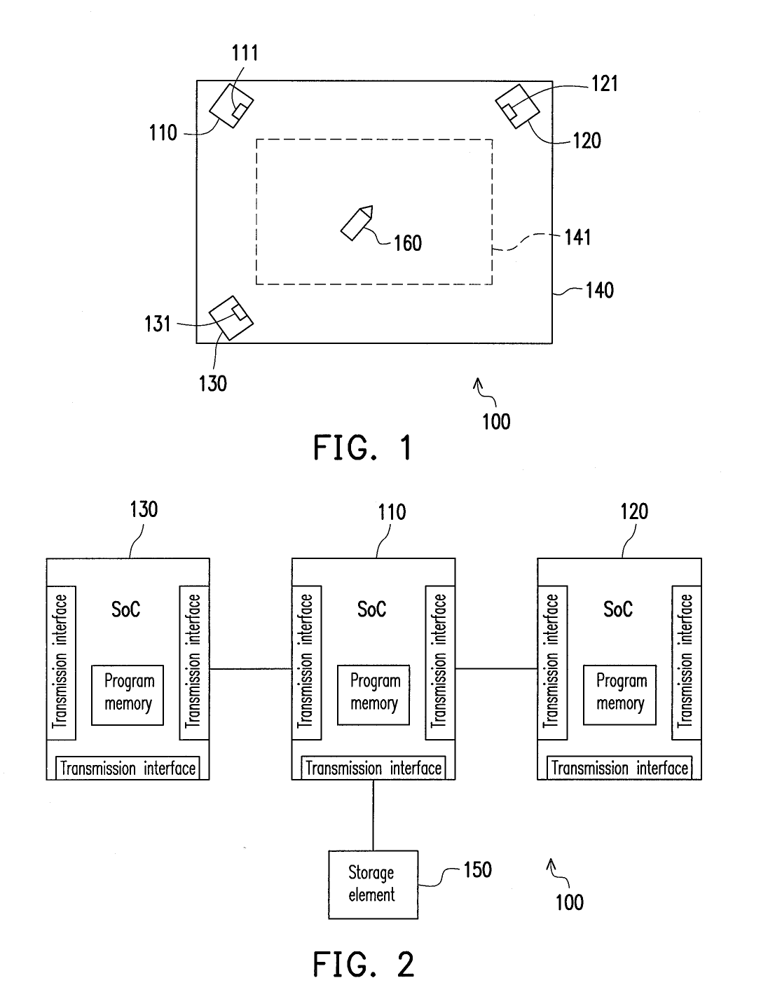

FIG. 1 is a schematic top view of architecture of an optical touch module according to an embodiment of the present invention. FIG. 2 is a schematic view of connection architecture of a plurality of SoCs shown in FIG. 1 according to an embodiment of the present invention. Referring to FIG. 1 and FIG. 2, an optical touch module 100 may be disposed on a substrate 140. In this embodiment, the architecture of the optical touch module 100 includes a first SoC 110, a second SoC 120, a third SoC 130, and a storage element 150. The substrate 140 has a touch region 141. The first SoC 110, the second SoC 120, and the third SoC 130 are electrically connected to one another and disposed around the touch region 141.

The first SoC 110 has an image sensor 111, the second SoC 120 has an image sensor 121, and the third SoC 130 has an image sensor 131. At least one light source is included around the touch region 141. This light source emits a light beam entering the touch region 141 for the image sensors 111, 121, and 131 to shoot/sense an image of the touch region 141. When a touching object 160 enters the touch region 141, the image sensors 111, 121, and 131 can shoot/sense a picture/image having the touching object 160. In some embodiments, a light-emitting element may be disposed in the optical touch module 100 as the light source of the touch region 141. In other embodiments, if the substrate 140 is a display panel, a light source of the display panel may be used as the light source of the touch region 141.

The first SoC 110, the second SoC 120, and the third SoC 130 respectively perform image processing/analyzing algorithm to process images sensed by the respective image sensors. In this way, the touching object 160 is conveniently located, and a location signal is transmitted to an operating platform, so that the operating platform determines a position of the touching object 160 with respect to the touch region 141, thereby implementing a touch function.

In some embodiments, the first SoC 110 may be a network camera chip. In other words, the first SoC 110 may be integrated with a network camera chip to form a single chip.

The substrate 140 may be a plane substrate of any material, which may be a rigid or soft material, such as a plastic substrate and a metal substrate. Furthermore, the substrate 140 may be a transparent or opaque substrate. If the substrate 140 is applied to a touch display device, the substrate 140 may be a display panel or a display element. For example, if the optical touch module 100 is applied to the display element, the display element may have the touch function. The display element has a display surface and a touch region 141 before the display surface. Also, for example, the touch region 141 may be a display region of the display panel.

Furthermore, in some embodiments, the third SoC 130 may be omitted according to design requirements of a product. In other embodiments, the architecture of the optical touch module 100 may further include a fourth SoC, and the fourth SoC is disposed around the touch region 141. Change of the embodiments may be derived by analogy with reference to the teaching of this embodiment.

Referring to FIG. 2, the optical touch module 100 uses the plurality of SoCs 110, 120, and 130 including the image sensors. The SoC 120 and the SoC 130 are respectively electrically connected to the SoC 110 through a transmission interface. The transmission interface may be a transmission interface of any specification, such as a Serial Bus and a Parallel Bus. In this embodiment, the SoCs 110, 120, and 130 are the same. The SoCs may be designated as different roles by performing bounding option on some pins of the SoCs. For example, for the optical touch module 100, the three SoCs 110, 120, and 130 may be respectively designated as Master, Slave 1, and Slave 2.

In order to complete different tasks of the roles and expand the use flexibility, all of the SoCs include program RAMs, in which programs to be executed can be loaded from outside. For example, for the SoC 110, firmware for controlling the SoC 110 and the image sensor 111 is stored in a programmable non-volatility memory, for example, a read only memory (ROM) or a FLASH memory, in the SoC 110, and touch data is stored in the program RAM. The touch data may be an execution program (for example, an image processing application program) or a related image processing parameter. Since the program RAM is a volatility memory, the stored data disappears as a power supply is cut off. Therefore, during power-on or booting, the SoC 110 necessarily loads the data (the program or the parameter) to be executed from the outside. Therefore, if the image processing program or parameter of the SoC 110 needs to be adjusted/changed, the SoC 110 does not need to be reprogrammed. For operation of the SoCs 120 and 130, reference may be made to related description of the SoC 110. Therefore, this embodiment can improve the flexibility and efficiency in the process of adjusting/changing the image processing program or parameter.

The optical touch module 100 shown in FIG. 2 is taken as an example. Data (first data, second data, and third data) required by the three SoCs 110, 120, and 130 is stored in a storage element 150, and related data of the SoCs has different starting addresses. The first data, the second data, and the third data may be an image processing program or an image processing parameter required by the SoCs 110, 120, and 130 or other execution programs or parameters.

The storage element 150 is a programmable non-volatility memory, for example, a Serial Flash or another type of flash memory. The storage element 150 is only electrically connected to one SoC (for example, the first SoC 110). In other embodiments, the storage element 150 may be connected to the SoC 120 or the SoC 130. After the system is booted up, the first SoC 110 reads the first data, the second data, and the third data stored in the storage element 150 and transmits the second data and the third data to the second SoC 120 and the third SoC 130 respectively. The first data, the second data, and the third data are stored in the program RAMs in the SoCs 110, 120, and 130 respectively. The SoCs 110, 120, and 130 respectively process the image of the touch region 141 according to the first data, the second data, and the third data in the program RAMs. Therefore, when the image processing program or parameter required by the SoCs 110, 120, and 130 is adjusted/changed, only the content of the storage element 150 needs to be updated, and the SoCs 110, 120, and 130 do not need to be reprogrammed one by one.

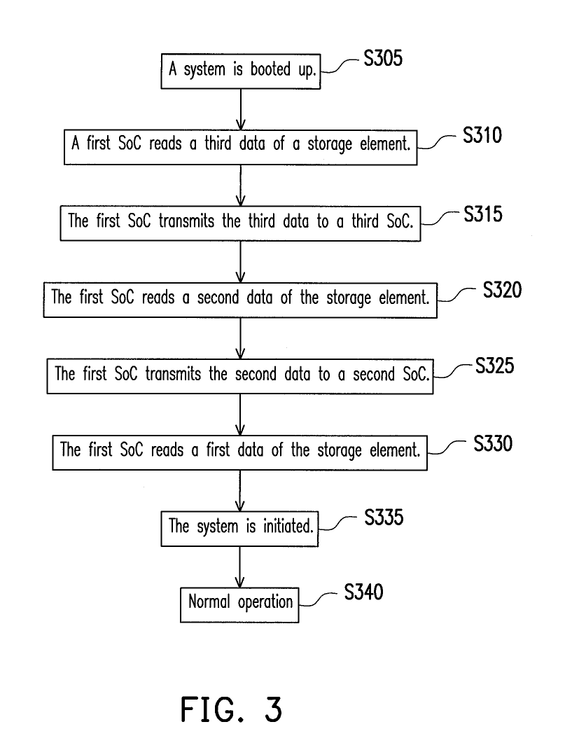

FIG. 3 is a flow chart of a data loading method of the optical touch module 100 shown in FIG. 2 according to an embodiment of the present invention. Referring to FIG. 2 and FIG. 3, when the system is powered on or booted up, Micro Controller Units (MCUs) included in the SoCs 110, 120, and 130 start to operate to complete the most basic system initiation and determine roles played by the SoCs 110, 120, and 130 in the whole system (Step S305). After the determination is completed, the first SoC 110 starts Direct Memory Access (DMA) to the storage element 150, so as to read the third data (for example, the execution program or parameter) of the third SoC 130 form a specific address of the storage element 150, and register the third data in the program RAM of the first SoC 110 (Step S310). The first SoC 110 communicates with the third SoC 130 through a transmission interface connected to the third SoC 130 to set the third SoC 130 in preparation for DMA to the transmission interface. After the setting is completed, the first SoC 110 transmits the third data registered in the program RAM to the third SoC 130 through the transmission interface (Step S315). After receiving the third data, the third SoC 130 directly puts the third data into the program RAM of the third SoC 130. In a subsequent normal operation (Step S340), the third SoC 130 processes the image of the touch region 141 according to the third data.

After Step S315 is completed, the first SoC 110 starts the DMA to the storage element 150, so as to read the second data (for example, the execution program or parameter) of the second SoC 120 form a specific address of the storage element 150, and register the second data in the program RAM of the first SoC 110 (Step S320). The first SoC 110 communicates with the second SoC 120 through a transmission interface connected to the second SoC 120 to set the second SoC 120 in preparation for DMA to the transmission interface. After the setting is completed, the first SoC 110 transmits the second data registered in the program RAM to the second SoC 120 through the transmission interface (Step S325). After receiving the second data, the second SoC 120 directly puts the second data into the program RAM of the second SoC 120. In the subsequent normal operation (Step S340), the second SoC 120 processes the image of the touch region 141 according to the second data.

After Step S325 is completed, the first SoC 110 starts DMA to the first SoC 110, so as to put the first data (for example, the execution program or parameter) belonging to the first SoC 110 in the program RAM of the first SoC 110 (Step S330). At this time, the program RAM of the first SoC 110 no longer belongs to a temporary-storage medium. The first SoC 110 communicates with the SoCs 120 and 130 through the transmission interface to notify the SoCs 120 and 130 of checking whether programs in the program RAMs of the SoCs 120 and 130 are valid, and complete other system initiation not yet completed (Step S335). Finally, the SoCs 110, 120, and 130 start to execute the programs in the respective program RAMs, and the optical touch module 100 starts to enter normal operation from this moment (Step S340).

It can be known from the above description that, before the second data and the third data are transmitted to a destination, the program RAM of the first SoC 110 is mainly used for registration, and then the second data and the third data are transmitted through the transmission interface. However, in practice, it should be noted that, before the fire data, the second data, and the third data reach the destination, a Program Counter of the MCU cannot point to the program RAM; otherwise, unexpected error may be generated by executing uncertain program content.

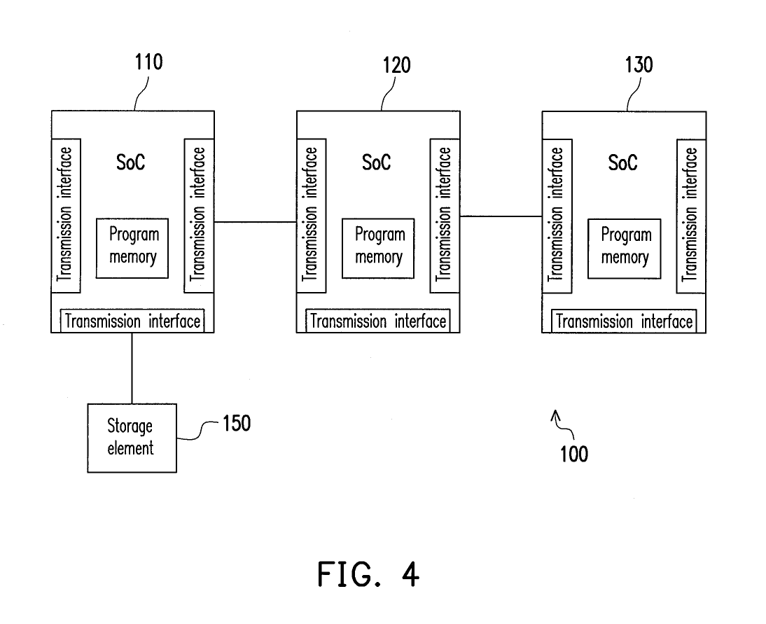

FIG. 4 is a schematic view of connection architecture of a plurality of SoCs shown in FIG. 1 according to another embodiment of the present invention. For the embodiment shown in FIG. 4, reference may be made to related descriptions of FIG. 1 and FIG. 2. The difference from FIG. 2 is that, in the optical touch module 100 shown in FIG. 4, the third SoC 130 is electrically connected to the second SoC 120.

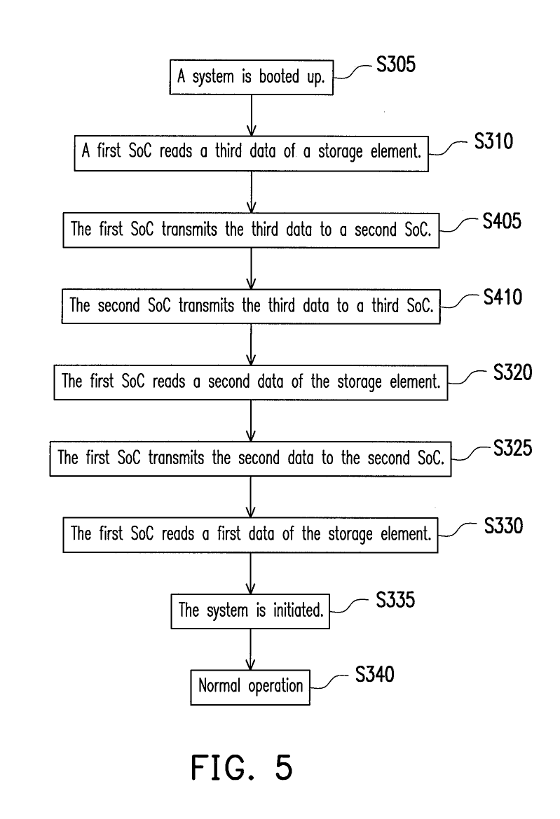

FIG. 5 is a flow chart of a data loading method of the optical touch module 100 shown in FIG. 4 according to another embodiment of the present invention. For Steps S305, S310, and S320 to S340 shown in FIG. 5, reference may be made to related description of FIG. 3. The difference from FIG. 3 is that, Steps S405 and S410 of FIG. 5 replace the Step S315 of FIG. 3.

Referring to FIG. 4 and FIG. 5, after Step S310 is completed, the first SoC 110 communicates with the second SoC 120 through a transmission interface connected to the second SoC 120 to set the second SoC 120 in preparation for DMA to the transmission interface. After the setting is completed, the first SoC 110 transmits the third data registered in the program RAM to the second SoC 120 through the transmission interface (Step S405). After receiving the third data, the second SoC 120 registers the third data into the program RAM of the second SoC 120. The second SoC 120 communicates with the third SoC 130 through a transmission interface connected to the third SoC 130 to set the third SoC 130 in preparation for DMA to the transmission interface. After the setting is completed, the second SoC 120 transmits the third data registered in the program RAM to the third SoC 130 through the transmission interface (Step S410). In a subsequent normal operation (Step S340), the third SoC 130 processes the image of the touch region 141 according to the third data.

After Step S410 is completed, Step S320 is performed. For Steps S320 to S340, reference may be made to description of FIG. 3, and details will not be described herein again.

To sum up, the embodiments provide the architecture and the data loading method of the optical touch module. The SoCs 110, 120, and 130 include the program RAMs, in which the data (for example, the program or parameter) to be executed can be loaded from outside. When the data of the SoCs 110, 120, and 130 is adjusted/changed, only the content of the storage element 150 connected to the first SoC 110 needs to be changed, and the SoCs 110, 120, and 110 do not need to be reprogrammed one by one. Therefore, the embodiments of the present invention can improve the flexibility and efficiency in the process of adjusting/changing the data of the SoCs 110, 120, and 110.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An architecture of an optical touch module, comprising:
a first system-on-chip (SoC) and a second SoC, electrically connected to each other, disposed around a touch region of a substrate, and each comprising an image sensor for sensing an image of the touch region; and
a storage element; electrically connected to the first SoC,
wherein the first SoC reads a first data and a second data stored in the storage element and transmits the second data to the second SoC, and the first SoC and the second SoC respectively process the images of the touch region according to the first data and the second data.

2. The architecture of the optical touch module according to the claim 1, wherein the first data and the second data are respectively execution programs or image processing parameters of the first SoC and the second SoC.

3. The architecture of the optical touch module according to the claim 1, wherein the storage element is a programmable non-volatility memory.

4. The architecture of the optical touch module according to the claim 1, further comprising:
a third SoC, electrically connected to the first SoC, disposed around the touch region, and comprising an image sensor for sensing an image of the touch region,
wherein the first SoC further reads a third data stored in the storage element and transmits the third data to the third SoC, and the third SoC processes the image of the touch region according to the third data.

5. The architecture of the optical touch module according to the claim 1, further comprising:
a third SoC, electrically connected to the second SoC, disposed around the touch region, and comprising an image sensor for sensing an image of the touch region,
wherein the first SoC further reads a third data stored in the storage element and transmits the third data to the third SoC through the second SoC, and the third SoC processes the image of the touch region according to the third data.

6. The architecture of the optical touch module according to the claim 1, wherein the first SoC is a network camera.

7. The architecture of the optical touch module according to the claim 1, wherein the substrate is a display panel, and the touch region is a display region of the display panel.

8. A data loading method of an optical touch module, wherein the optical touch module comprises a first system-on-chip (SoC) and a second SoC, electrically connected to each other, disposed around a touch region of a substrate, and each comprising an image sensor for sensing an image of the touch region, the data loading method comprising:
enabling the first SoC to read a second data stored in a storage element;
transmitting the second data from the first SoC to the second SoC, wherein the second SoC processes the image of the touch region according to the second data; and
enabling the first SoC to read a first data stored in the storage element, wherein the first SoC processes the image of the touch region according to the first data.

9. The data loading method of the optical touch module according to the claim 8, wherein the first data and the second data are respectively execution programs or image processing parameters of the first SoC and the second SoC.

10. The data loading method of the optical touch module according to the claim 8, wherein the optical touch module further comprises a third SoC, electrically connected to the first SoC, disposed around the touch region, and comprising an image sensor for sensing an image of the touch region, and the data loading method further comprises:
enabling the first SoC to read a third data stored in the storage element; and
transmitting the third data from the first SoC to the third SoC, wherein the third SoC processes the image of the touch region according to the third data.

11. The data loading method of the optical touch module according to the claim 8, wherein the optical touch module further comprises a third SoC, electrically connected to the second SoC, disposed around the touch region, and comprising an image sensor for sensing an image of the touch region, and the data loading method further comprises:
enabling the first SoC to read a third data stored in the storage element;
transmitting the third data from the first SoC to the second SoC; and
transmitting the third data from the second SoC to the third SoC, wherein the third SoC processes the image of the touch region according to the third data.
